(19) United States
(12) Patent Application Publication
(10) Pub. No.: US 2015/0195371 A1
(43) Pub. Date: Jul. 9, 2015

(54) CHANGING A CACHE QUEUE BASED ON USER INTERFACE POINTER MOVEMENT

(71) Applicants: Maciej Szymon Nowakowski, Zurich (CH); Balazs Szabo, Zurich (CH)

(72) Inventors: Maciej Szymon Nowakowski, Zurich (CH); Balazs Szabo, Zurich (CH)

(73) Assignee: Google Inc., Mountain View, CA (US)

(21) Appl. No.: 13/593,878

(22) Filed: Aug. 24, 2012

(51) Int. Cl. H04L 29/08; G06N 7/00; G06F 3/0481

(52) U.S. Cl. CPC H04L 67/2842; G06F 3/04812; G06N 7/005

(57) ABSTRACT

A method, system and non-transitory computer readable medium encoding instructions for managing a cache associated with a user interface having a pointer are provided. The method begins by tracking the position of the pointer on the user interface. A future position of the pointer on the user interface is predicted and a likelihood that the pointer will select a first screen object of a plurality of screen objects is determined based on the predicted future pointer position. Finally, a cache of screen objects, and a priority queue of screen objects to prefetch are managed based on the determined likelihood that the pointer will select the first screen object.

### FIELD

The present application generally relates to user interfaces.

### BACKGROUND

As web content becomes more popular, users continue to desire faster response times from their web browsers. Link prefetching describes an approach to improving web browser performance whereby information associated with hypertext links on a viewed page is cached in advance of the link being activated.

Many modern browsers downloads the contents of sites before the user clicks on any link. This makes loading pages much faster as the content is already available for the browser to render. One downside of this technique is that it wastes a lot of bandwidth, since not all links will be visited.

### BRIEF SUMMARY

Embodiments described herein relate to managing a cache associated with a user interface having a pointer. According to an embodiment, a method of managing a cache associated with a user interface having a pointer begins by tracking the position of the pointer on the user interface. A future position of the pointer on the user interface is predicted and a likelihood that the pointer will select a first screen object of a plurality of screen objects is determined based on the predicted future pointer position. Finally, a cache of screen objects, and a priority queue of screen objects to prefetch are managed based on the determined likelihood that the pointer will select the first screen object.

According to another embodiment, a system for managing a cache associated with a user interface having a pointer is provided. The system includes a pointer tracker configured to track the position of the pointer on the user interface and a position predictor configured to predict a future position of the pointer on the user interface. A likelihood determiner is configured to then determine a likelihood that the pointer will select a first screen object of a plurality of screen objects based on the predicted future pointer position. Finally, a cache manager is configured to manage a cache of screen objects based on the determined likelihood, and a queue manager is configured to manage a priority queue of screen objects to prefetch based on the determined likelihood that the pointer will select the first screen object.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 shows a pointer and links on a user interface of a web page, according to an embodiment.

FIG. 2 shows a web browser having a pointer predictor, a queue manager and a cache manager, according to an embodiment.

FIG. 3 shows an example of pointer tracking with links on a user interface, according to an embodiment.

FIG. 4 shows a priority queue and cache in a series of states, according to an embodiment.

FIG. 5 is a flowchart of a method of managing a cache associated with a user interface having a pointer, according to an embodiment.

FIG. 6 depicts an example computer system that can be used to implement an embodiment.

### DETAILED DESCRIPTION OF EMBODIMENTS

The following detailed description refers to the accompanying drawings that illustrate exemplary embodiments. Embodiments described herein relate to providing systems, methods and computer readable storage media for managing a cache associated with a user interface. Other embodiments are possible, and modifications can be made to the embodiments within the spirit and scope of this description. Therefore, the detailed description is not meant to limit the embodiments described below.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

It should be noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art given this description to incorporate such a feature, structure, or characteristic in connection with other embodiments whether or not explicitly described.

### Web Browser

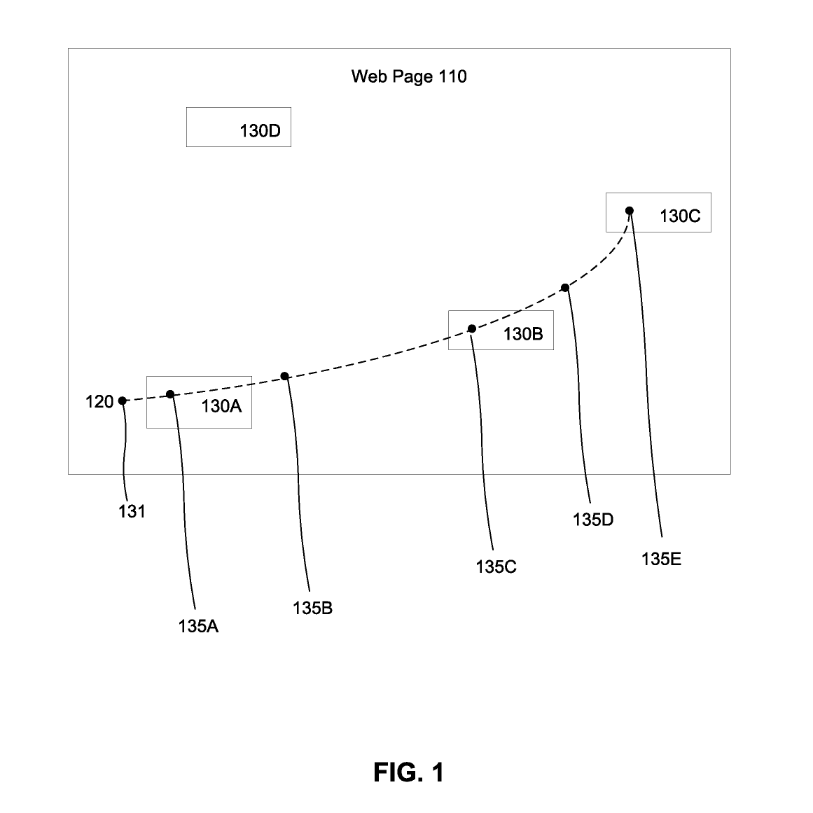

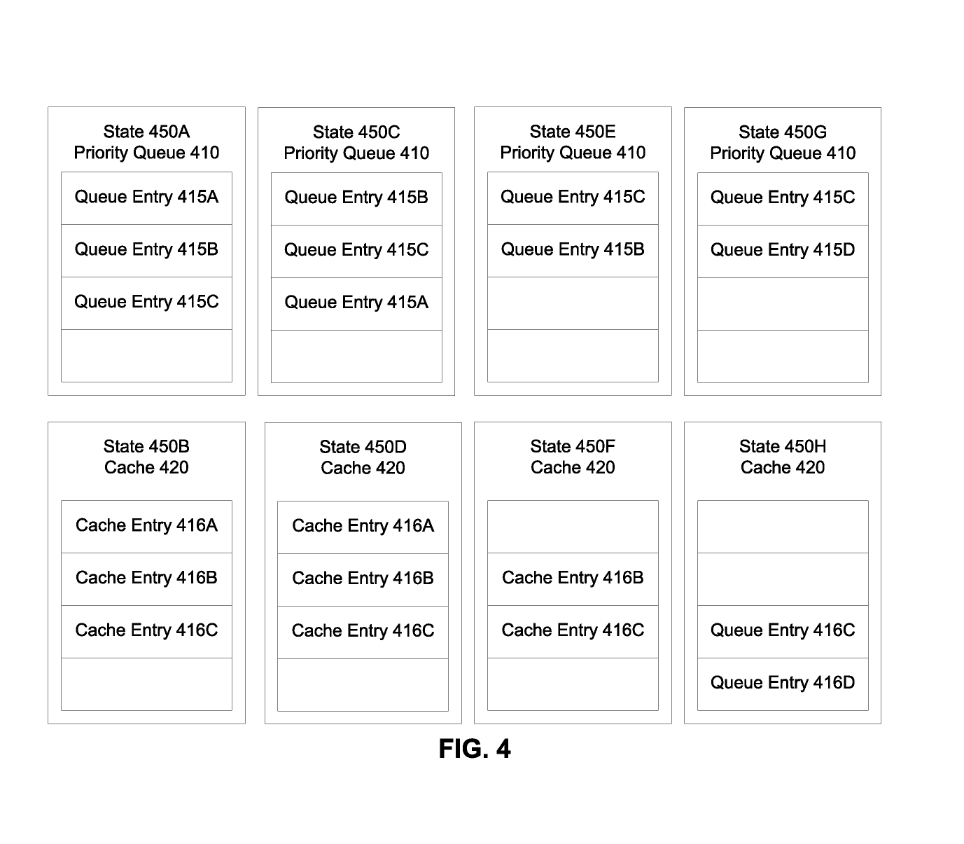

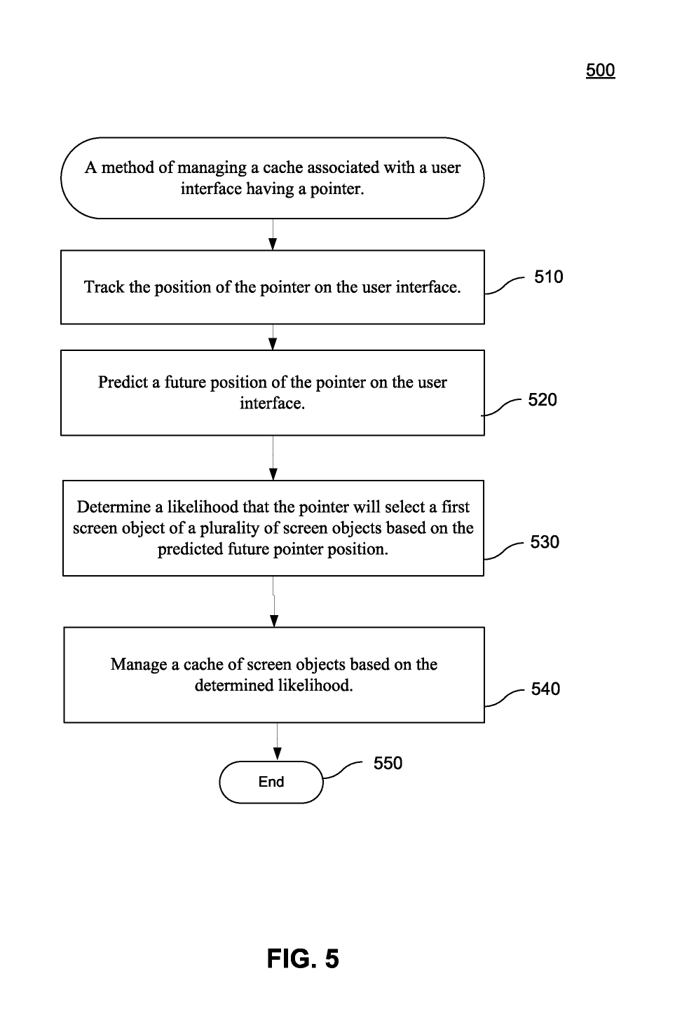

FIG. 1 illustrates user manipulation of web page 110 using a pointer. Web page 110 includes links 130A-D, pointer path 120, beginning point 131 and points 135A-E. Some embodiments described herein implement a prediction algorithm that predicts user intent to select user interface screen objects. Pointer path 120 represents a path of a user interface pointer over a period of time. As described in events E1-E3 below, an embodiment predicts the future position of the user interface pointer and determines a likelihood that the user will select links 130A-D. As described with reference to FIGS. 4 and 5 below, an embodiment uses the determined likelihood to manage a cache of web page 110 screen objects. Screen objects managed by an embodiment include subject matter associated with links 130A-D.

As used typically herein, a user interface pointer can be controlled by a mouse, trackball, optical mouse, touchpad, touch screen or other pointing device, and is used to manipulate user interface objects.

### Pointer Predictor

In embodiments described herein, the specifics of pointer tracking are implementation specific. Further, the determination of a likelihood of selecting a particular screen object is also implementation specific. It is helpful to consider three events E1-E3 listed below:

E1. At point 135A, in an example, the user interface pointer is moving across link 130A toward point 135B. Different embodiments use different approaches to tracking and predicting path 120 and the likelihood of selecting links 130A-D. In this example, because at point 135A, the pointer is moving toward point 135B, the likelihood of selecting link 130A is lower than for links 130B-C. Because link 130D is in a different direction, the likelihood of selecting link 130A is relatively higher. Based on the speed of the pointer, links 130B or 130C may have the highest likelihood. A faster pointer speed would suggest a higher likelihood of selecting link 130C, while a slower pointer speed would suggest a higher likelihood of selection for link 130B. As noted above, these factors and predictions are intended to be non-limiting and can vary in different embodiments.

E2. At point 135D, the likelihood of selecting link 130B decreases and the likelihood of selecting link 130C increases. Depending upon the speed of the pointer along path 120, the likelihood of selecting link 130D can also be increased. It is important to note that, in an embodiments, the likelihood of selecting links 130A-D changes dynamically as the pointer moves along path 120. It can change based on different spatial characteristics, such as pointer speed and direction.

E3. At point 135E, the pointer stops on link 130C and an embodiment raises the relative likelihood of selecting link 130C. Other link selection likelihoods can be based on distance from point 135E, e.g., link 130B having the next highest likelihood and link 130D being ranked next most likely.

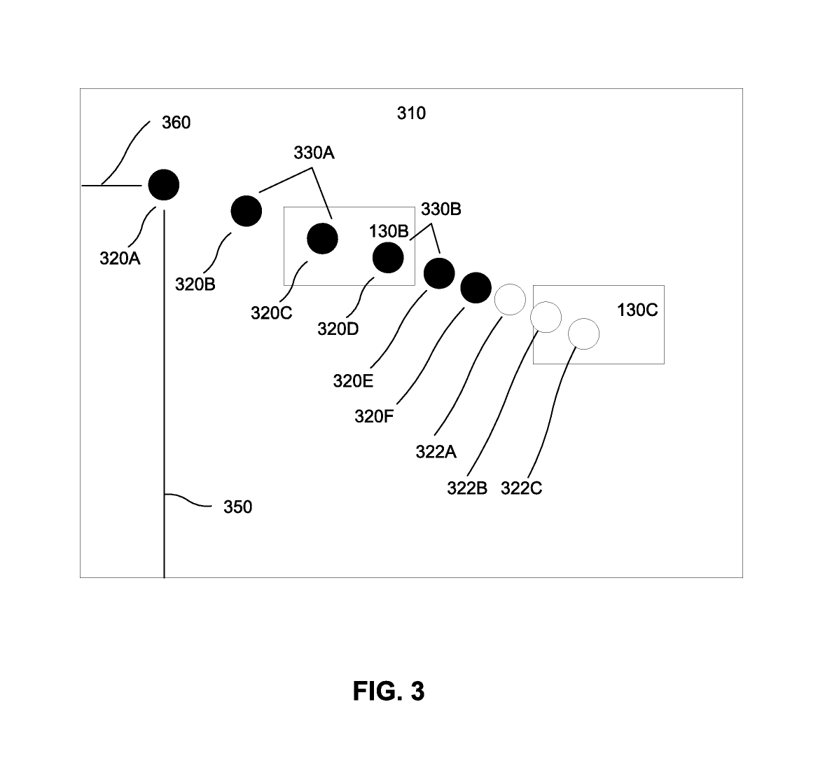

As would be appreciated by one having skill in the relevant art(s), given the description herein, predicting aspects of user manipulation of web page 110 user interface can be performed in a variety of ways. An example of a similar pointer prediction is described in U.S. patent application Ser. No. 13/183,035 ('035 application) filed on Jul. 14, 2011, entitled “Predictive Hover Triggering” which is incorporated by reference herein in its entirety, although embodiments are not limited to this example. A more detailed view of pointer tracking and prediction is shown and described with reference to FIG. 3.

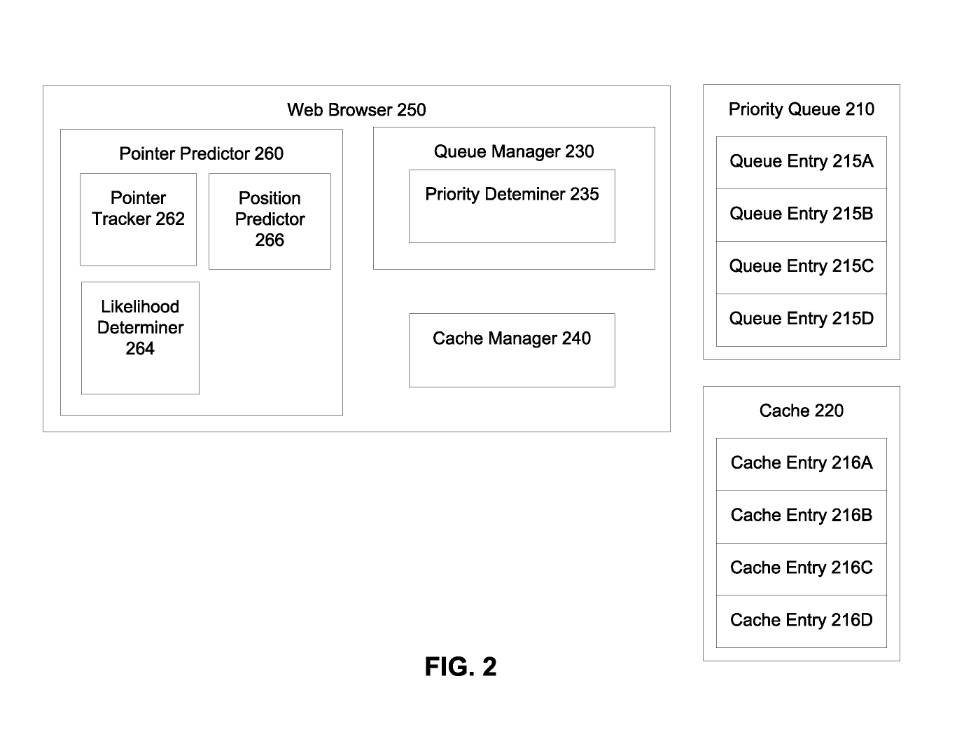

FIG. 2 is a block diagram of web browser 250, priority queue 210 and cache 220. Web browser 250 includes pointer predictor 260, queue manager 230 and cache manager 240. Pointer predictor 260 includes pointer tracker 262, position predictor 266 and likelihood determiner 264. Queue manager 230 includes priority determiner 235. Priority queue 210 has queue entries 215A-D and cache 220 has cache entries 216A-D. It should be appreciated that the placement of components is not intended to be limiting of embodiments. Different functions described as being performed by components can be performed by different components. For example, in a different embodiment, the functions of one or more of queue manager 230, cache manager 240 and pointer predictor 260 are performed by operating system functions and not by web browser 250.

As used typically herein cache 220 (also known as a “web cache”) is a storage resource for storing web content based on hyperlinks (“links”) on web page 110. As noted in the background section above, to improve a user's web experience, web content linked to by links on web page 110 is loaded before it is requested by web browser 250. This type of “pre-loading” is also termed pre-fetching/prefetching and is known in the art. This description of a web cache is not intended to be limiting of embodiments. One having skill in the relevant art(s), given the description herein, will appreciate that different embodiments can apply to different types of caches and cache management techniques.

As used typically herein priority queue 210 is a queue that specifies the priority in which web content is prefetched into cache 220. In one approach, higher priority content is fetched before lower priority content. In another approach, browser prefetching of content items can be performed in parallel. Using this approach, high priority content can be fetched in parallel with lower priority content. This lower priority content may have a priority only slightly below the prefetched priority content.

It should also be noted that “fetching content” can be multiple operations over time, and during these operations, requests can be changed based on the browser's state of knowledge about the web page and the user's preferences. For example, the browser initially knows only the URL of the web page and, based on this in some circumstances, only a single thread may be dedicated to fetching web page content. After downloading and interpreting the main page however, the browser reads references to different types of high and low priority items, e,g., images, stylesheets, etc. These items can alter the browsers allocation of resources and fetching strategies.

In addition, every time that some part of higher priority web page content is loaded, because fetching could have been performed in parallel, lower priority content may have already been loaded.

While priority queue 210 is shown as an ordered list of queue entries 215A-D, it should be appreciated that other factors can also influence the order in which web content it prefetched.

In pointer predictor 260, pointer tracker 262 receives measurements from the movement of the pointer along path 120. These measurements can include two dimensional position values and a determined speed of the pointer at given points. Based on these measurements, position predictor 266 predicts future pointer positions. Based on the received measurements and predictions from pointer position predictor 266, likelihood determiner 264 determines a likelihood that the user will select links 130A-D.

As described further with reference to FIG. 4 below, based on the likelihoods determined by likelihood determiner 264, cache manager 240 manages cache 220. One having skill in the relevant art(s), given the description herein, will appreciate different operations that can be performed with respect to cache 220. Adding and evicting cache entries 216A-D are example cache operations performed by cache manager.

As noted in the background section above, and with reference to FIG. 1, cache entries 216A-D can be fetched after they are needed or prefetched before they are needed. An embodiment of likelihood determiner 264 can improve the operation of web browser 250 by enabling cache manager 240 to reduce the incidence of prefetching data that goes unused.

In a variation of the embodiment where cache manager 240 is uses likelihood determiner 264 to manage cache 220, queue manager 230 also indirectly manages cache 220. Priority queue 210 is the list of items to be fetched/prefetched by embodiments. In an example where cache 220 is empty, based on the entry order of queue entries 215A-D, queue entry 215A is prefetched first, followed by queue entry 215B. In an embodiment, queue manager 230 uses priority determiner 235 to update the order of the priority queue entries 215A-D based on output from pointer predictor 260. Priority determiner 235 can also assign a prefetch priority to screen objects not found in either queue entries 215A-D or cache 220.

FIG. 3 illustrates an embodiment that predicts the future position of a pointer. FIG. 3 depicts several pointer position samples 320A-F taken over a period of time, and estimated future positions 322A-C. In accordance with an embodiment, pointer positions are observed and stored as a point moves within a user interface over time. The stored pointer positions are used to determine the velocity and trajectory of the pointer. Using the determined velocity and trajectory, a future pointer position can be predicted and/or estimated.

In an embodiment, the pointer position samples are X, Y values storing the position of the pointer on user interface screen 310 at a particular moment in time. For some embodiments below, position samples are taken of pointer position at different intervals. In an embodiment, the intervals are regular, taken at an interval that can capture very small changes in mouse movement, e.g., a sampling interval of an embodiment once every 20 milliseconds. Another sampling interval for another embodiment is once every 30 milliseconds. As would be appreciated by one having skill in the relevant art(s), with access to the teachings herein, different sampling intervals can be chosen for embodiments based on a balance between the processing cost and the performance of the implemented data models.

As depicted on FIG. 3 for example, pointer point 320A can be sampled and stored using the values of X 250 and Y 260 at point T=1. For convenience, this type of sample is discussed herein using the notation “(x, y, time).” Because, in one example depicted on FIG. 3, these samples are taken at regular intervals, a larger distance between samples indicates a higher velocity than a smaller distance. For example, because, on FIG. 3 distance 330A between points 320B and 320C is shown as larger than distance 330B between 320D and 320E, the pointer velocity is slower during the 330B span. As described in the '035 application, using similar velocity measurement's can enable an instantaneous velocity approach to predicting the future position of a moving pointer on interface screen 310 according to an embodiment.

As described in the '035 application, other approaches can be used to predict pointer position at a future point. Another approach to predicting future pointer position uses a linear regression analysis. In this embodiment, the collected data points and a measured trajectory from step analyzed using linear regression analysis to predict a future data point. Another approach that can be processing intensive, in an embodiment, is to use a least-squares fit to compute an estimate of the acceleration of the pointer. In this embodiment, the use of a higher-order polynomial model is able to model acceleration as well as velocity of the pointer.

It should be appreciated that approaches selected to predict future pointer positions may be selected, by an embodiment, based on the amount of processing required and the performance requirements of the user interface. A more accurate approach, for example, using current hardware configurations may be able to be used given the performance needs of the user interface.

As discussed below, once a future position of the pointer is estimated, an embodiment combines the estimated future pointer position, the current pointer position and characteristics of the screen object to estimate the likelihood that a particular screen object will be selected.

### Cache Management

FIG. 4 shows a priority queue 410 and cache 420 in a series of eight (8) example states 450A-H, according to an embodiment. Each state 450A-H shows either priority queue 410 or cache 420, and a combination of respective queue entries 415A-D or cache entries 416A-D. Priority queue 410 entries 415A-D and cache 420 entries 416A-D correspond to respective links 130A-D from FIG. 1. For example, when queue entry 415A appears at the top/highest priority of priority queue 410, this indicates that link 130A has that top priority for fetching/prefetching by embodiments. States 450A-H can be considered sequentially, with the state of priority queue 410 leading to the state of cache 420 in the next state. For example, the state of cache 420 in state 450B results from state 450A of priority queue 410.

In an example listed below, each priority queue 410 state 450A, 450C, 450E and 450G, is described, along with respective cache 420 states 450B, 450D, 450F and 450H. These example states are intended to illustrate the operation of an embodiment and are not intended to be limiting. It should be noted that FIG. 4 is a simplified view of prefetching operations, where prefetched webpages don't have additional content to be fetched later. Also, principles described herein can be used with parallel fetching approaches as well. One having skill in the relevant art(s), given the description herein, will appreciate that different embodiments can beneficially perform additional cache 420 and priority queue 410 operations under different circumstances.

State 450A: This state corresponds to pointer position at beginning point 131 of path 120 from FIG. 1. At point 135A, in an example, the user interface pointer is starting to move toward link 130A. Because link 130A is the closest, the likelihood of selecting link 130A is the highest, followed by links 130B-C. Based on screen position, in this example, link 130D is not in priority queue 410 at this state. In another embodiment, all links on web page 110 are in priority queue 410.

State 450B: Based on queue entries 415A-C in priority queue 410 in state 450A, cache 420 prefetches links 130A-C and stores these in cache 220 as cache entries 416A-C. For the purposes of this example, it is assumed that that prefetching of cache entries 416A-C is accomplished almost instantaneously. One having skill in the relevant art(s), given the description herein, will appreciate that actual fetching/prefetching links 130A-C would take longer.

In an alternative implementation approach, when a content item is fetched and stored in cache 420, it is automatically removed from priority queue 410. Thus, in this alternative approach, content items that have already been fetched and stored in cache 420 are, in the future, excluded from the fetch probability determinations performed by embodiments.

Using this alternative implementation approach, at state 450B, after links 130A-C are prefetched and stored in cache 420, queue entries 415A-C (referencing links 130A-C) are evicted from priority queue 410.

State 450C: This state corresponds to pointer position point 135A on path 120 from FIG. 1. As described in the example from FIG. 1 above, at point 135A the user interface pointer is moving across link 130A toward point 135B. In this example, because at point 135A, the pointer is actively moving toward position 135B, the likelihood of selecting link 130A is lower than for links 130B-C. Because link 130D is in a different direction, the likelihood of selecting link 130A is relatively higher. Based on this likelihood determination, priority queue 410 is modified at state 450C. Because of the lower likelihood of selecting queue entry 415A, this queue entry is moved to the bottom/lowest priority portion of priority queue 410. Similarly, based on the higher likelihood of selecting queue entries 415B-C, these entries are respectively moved up in the priority queue 310.

In the alternative implementation approach described above, at state 450C, new content items are considered and stored as queue entries 415A-C. When considering content items on the web page, links 130A-C are excluded from consideration because they are already stored in cache 420.

State 450D: Because links 130A-C are already stored in cache entries 416A-C no additional retrieval is required at state 450D. In an embodiment, if a cache entry corresponding to a link is removed from priority queue 410, this entry is also evicted from cache 220. Because none of the queue entries 415A-C are removed at state 450C, no eviction of cache entries 416A-C from cache 420 is performed at state 450D.

In the alternative implementation approach, content items stored in cache 420 are evicted by conventional eviction approaches, and not based on priority queue 410. After a cache entry is freed up by eviction, in an embodiment, the system considers refilling the cache entry from content items referenced in priority queue 410. Also, after eviction of a content item from cache 420, in the alternative approach, the evicted content item is once again able to be stored in priority queue 410. Thus, when link 130A was prefetched into cache entry 416A, queue entry 415A was removed from priority queue 410. When cache entry 416A is evicted from cache 420A however, link 130A is considered, and can be reloaded in to priority queue 410 and, if warranted, cache 420.

State 450E: This state corresponds to pointer position point 135C on path 120 from FIG. 1. At point 135C, the likelihood of selecting links 130A or 130B decreases and the likelihood of selecting link 130C increases. In an embodiment, based on the low likelihood of selecting link 130A, an entry for this link is removed from priority queue 410, leaving only queue entries 415C and 415B. In another embodiment, queue entries are not removed from priority queue 410 based on determined likelihoods of user selection.

State 450F: As noted in the description of state 450D above, in an embodiment, based on the determined likelihood of a link being selected, a cache entry may be removed from cache 420. As shown in cache 420, at state 450F, based on the removal of queue entry 415A from priority queue 410, cache entry 416A is also removed. In a variation of this approach, if cache entry 416A were in the process of being fetched or prefetched, this process can be stopped based on the determined likelihood of the link associated with the cache entry being selected.

State 450G: This state corresponds to pointer position point 135D on path 120 from FIG. 1. In this example, based on speed and/or trajectory measurements collected and analyzed by an embodiment, queue entry 415D has been added to priority queue 410. Based on the trajectory, queue entry 415C is now the highest priority item in priority queue 410. Based on the approach discussed with an embodiment at state 450D and 450F,

State 450H: Similar to state 450F, based on the removal of queue entries 415A-B, corresponding cache entries 416A-B are evicted from cache 420.

### Method

FIG. 5 is a flowchart illustrating a computer-implemented method 500 of managing a cache associated with a user interface having a pointer, according to an embodiment. The method begins at stage 510 with the tracking of the position of the pointer on the user interface. For example, pointer tracker 262 tracks a pointer along path 120. Once stage 510 is completed, the method moves to stage 520.

At stage 520, a future position of the pointer on the user interface is predicted. For example, with the pointer at point 135B, position predictor 266 predicts that the pointer will be at point 135C at a future time. Once stage 520 is completed, the method moves to stage 530.

At stage 530, a likelihood that the pointer will select a first screen object of a plurality of screen objects is determined based on the predicted future pointer position. For example, based on predicted point 135C, likelihood determiner 264 predicts a likelihood that link 130B will be selected by the pointer. Once stage 530 is completed, the method moves to stage 540.

At stage 540, a cache of screen objects is managed based on the determined likelihood. For example, based on the likelihood of selection of link 130B, in state 450C shown on FIG. 4, cache manager 240 promotes queue entry 415B (associated with link 130B) to the top of priority queue 410. Based on the top priority, in state 450D, cache manager 240 maintains cache entry 416B (associated with link 130B) in cache 420. In another example of cache management by an embodiment, at state 450D, if cache entry 416B was not loaded into cache 420, cache manager 240 stops other prefetching activity to load cache entry 416B into cache 420.

In another embodiment (not shown), link 130B can have a lower priority than other links 130A, 130C and 130D. In this example, cache manager 240 can demote queue entry 415B lower in priority queue 410. Notwithstanding this lower priority, cache manager 240 can maintain cache entry 416B (associated with link 130B) in cache 420. In a variation of this embodiment, based on an even lower priority of link 130B, queue entry 415B can be evicted from both priority queue 410 and cache 420. The specifics of cache eviction logic are implementation specific, and would be appreciated by on having skill in the relevant art(s), given the description herein.

Once stage 540 is completed, the method ends at stage 550.

### Example Computer System Implementation

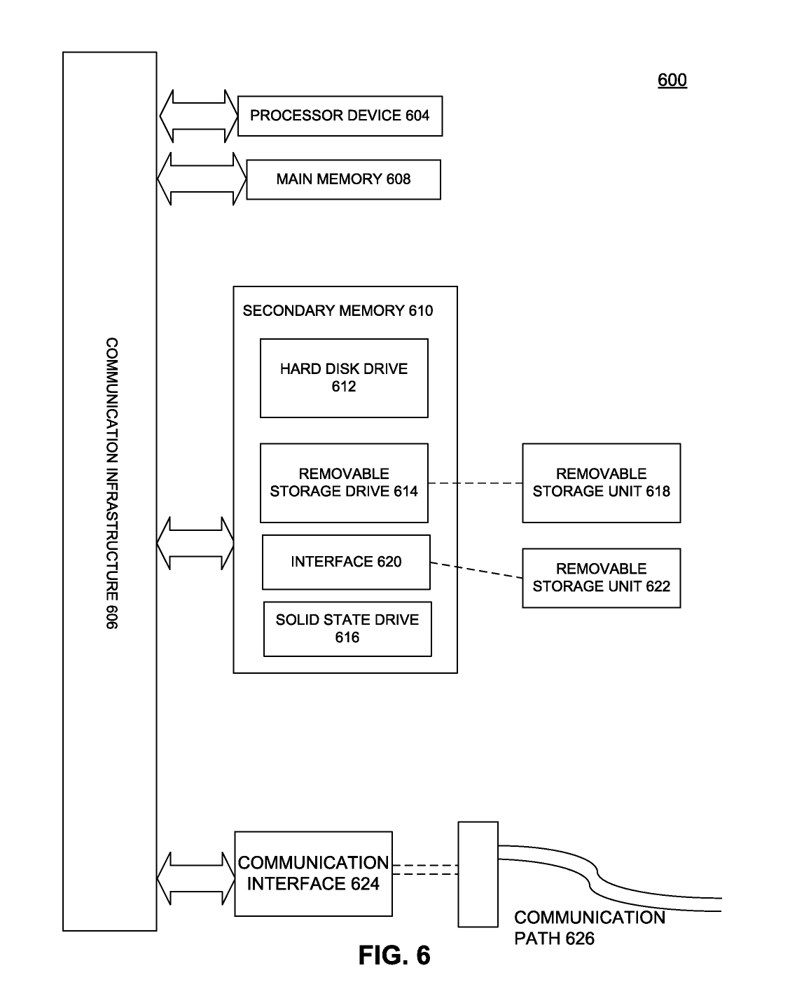

FIG. 6 illustrates an example computer system 600 in which embodiments, or portions thereof, may be implemented as computer-readable code. For example, portions of systems or methods illustrated in FIGS. 1-4, may be implemented in computer system 600 using hardware, software, firmware, tangible computer readable media having instructions stored thereon, or a combination thereof and may be implemented in one or more computer systems or other processing systems. Hardware, software or any combination of such may embody any of the modules/components in FIGS. 1-4 and any stage of method 500 illustrated in FIG. 5.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 606, for example, a bus, message queue, network or multi-core message-passing scheme.

Computer system 600 also includes a main memory 608, for example, random access memory (RAM), and may also include a secondary memory 610. Secondary memory 610 may include, for example, a hard disk drive 612, removable storage drive 614 and solid state drive 616. Removable storage drive 614 may include a floppy disk drive, a magnetic tape drive, an optical disk drive, a flash memory, or the like. The removable storage drive 614 reads from and/or writes to a removable storage unit 618 in a well known manner. Removable storage unit 618 may include a floppy disk, magnetic tape, optical disk, etc. which is read by and written to by removable storage drive 614. As will be appreciated by persons skilled in the relevant art, removable storage unit 618 includes a computer readable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in electronic, electromagnetic, optical, or other forms capable of being received by communications interface 624. This data may be provided to communications interface 624 via a communications path 626. Communications path 626 carries the data and may be implemented using wire or cable, fiber optics, a phone line, a cellular phone link, an RF link or other communications channels.

In this document, the terms “computer program medium” and “computer readable medium” are used to generally refer to media such as removable storage unit 618, removable storage unit 622, and a hard disk installed in hard disk drive 612. Computer program medium and computer readable medium may also refer to memories, such as main memory 608 and secondary memory 610, which may be memory semiconductors (e.g., DRAMs, etc.).

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the method illustrated by flowchart 800 of FIGS. 8A-C discussed above. Accordingly, such computer programs represent controllers of the computer system 600. Where the invention is implemented using software, the software may be stored in a computer program product and loaded into computer system 600 using removable storage drive 614, interface 620, hard disk drive 612 or communications interface 624.

Embodiments also may be directed to computer program products comprising software stored on any computer useable medium. Such software, when executed in one or more data processing device, causes a data processing device(s) to operate as described herein. Embodiments include any tangible computer useable or readable medium. Examples of tangible computer useable media include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

Embodiments described herein relate to methods, systems and computer readable media for managing a cache associated with a user interface having a pointer. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

1. A method of managing a cache associated with a user interface having a pointer, comprising:
tracking, using one or more computing devices, the position of the pointer on the user interface;
predicting, using the one or more computing devices, a future position of the pointer on the user interface;
determining, using the one or more computing devices, a likelihood that the pointer will select a first screen object of a plurality of screen objects based on the predicted future pointer position; and
managing, using the one or more computing devices, a cache of screen objects based on the determined likelihood; and
managing, using the one or more computing devices, a priority queue of the screen objects to prefetch based on the determined likelihood that the pointer will select the first screen object, wherein managing the priority queue of the screen objects further comprises removing a given screen object from the priority queue based at least on a low likelihood of the given screen object being selected.

2. The method of claim 1, wherein managing the cache of screen objects comprises storing an entry in the priority queue of screen objects to prefetch, wherein the entry is associated with the first screen object, and based on the determined likelihood that the pointer will select the first screen object.

3. The method of claim 2, wherein managing the cache of screen objects further comprises:
prefetching the first screen object to the cache based on the priority queue.

4. The method of claim 2, wherein managing the cache of screen objects further comprises:
evicting the first screen object from the cache based on the determined likelihood.

5. (canceled)

6. The method of claim 2, wherein:
an entry associated with a first screen object is removed from the priority queue after the first screen object is stored in the cache, and
determining the likelihood that the pointer will select the first screen object is only performed when the first screen object is not stored in the cache.

7. The method of claim 1, further comprising, repeating the stages of the method as the pointer moves in the user interface.

8. The method of claim 1, wherein tracking the position of the pointer on the user interface comprises tracking the position of a pointer controlled by a pointing device.

9. The method of claim 8, wherein tracking the position of a pointer controlled by a pointing device comprises tracking the position of a pointer controlled by a mouse pointing device.

10. The method of claim 8, wherein tracking the position of a pointer controlled by a pointing device comprises tracking the position of a pointer controlled by a touch screen.

11. The method of claim 1, wherein managing the priority queue of screen objects to prefetch further comprises updating a priority order of the screen objects in the queue.

12. A system for managing a cache associated with a user interface having a pointer, comprising:
a memory storing a plurality of screen objects; and at least one processor device, the at least one processor device comprising:
one or more processors coupled to the memory;
a pointer tracker in communication with the one or more processors and operative to track the position of the pointer on the user interface;
a position predictor in communication with the one or more processors and operative to predict a future position of the pointer on the user interface;
a likelihood determiner in communication with the one or more processors and operative to determine a likelihood that the pointer will select a first screen object of a plurality of screen objects based on the predicted future pointer position;
a cache manager in communication with the one or more processors and operative to manage a cache of screen objects based on the determined likelihood; and
a queue manager in communication with the one or more processors and operative to manage a priority queue of screen objects to prefetch based on the determined likelihood that the pointer will selected, wherein to manage the priority queue of the screen objects further comprises removing a given screen object from the priority queue based at least on a low likelihood of the given screen object being selected.

13. The system of claim 12, wherein the cache manager is further configured to prefetch a screen object to the cache based on the priority queue of screen objects.

14. The system of claim 12, wherein the cache manager is further configured to evict a screen object from the cache based on the determined likelihood.

15. The system of claim 12, wherein functions of system components are repeated as the pointer moves on the user interface.

16. The system of claim 12, wherein the position tracker is configured to track the position of a pointer controlled by a pointing device.

17. The system of claim 16, wherein the position tracker is further configured to track the position of a pointer controlled by a mouse pointing device.

18. The system of claim 16, wherein the position tracker is configured to track the position of a pointer controlled by a touch screen.

19. The system of claim 12, wherein the queue manager is further configured to update a priority order of the screen objects in the priority queue.

20. A non-transitory computer readable medium encoding instructions thereon that, in response to execution by one or more computing devices, cause the computing devices to perform a method of managing a cache associated with a user interface having a pointer, comprising:
tracking, using the one or more computing devices, the position of the pointer on the user interface;
predicting, using the one or more computing devices, a future position of the pointer on the user interface;
determining, using the one or more computing devices, a likelihood that the pointer will select a first screen object of a plurality of screen objects based on the predicted future pointer position;
managing, using the one or more computing devices, a cache of screen objects based on the determined likelihood; and
managing, using the one or more computing devices, a priority queue of screen objects to prefetch based on the determined likelihood that the pointer will select the first screen object, wherein managing the priority queue of the screen objects further comprises removing a given screen object from the priority queue based at least on a low likelihood of the given screen object being selected.
